(19) United States
(12) Patent Application Publication
(10) Pub. No.: US 2004/0181451 A1
(43) Pub. Date: Sep. 16, 2004

(54) Methods relating to multi-compartment laundry products

(75) Inventors: Christina Lynn Boeckerman, West Chester, OH (US); James Charles Theophile Roger Burckett-St. Laurent, Brussels (BE); Stefano Scialla, Rome (IT); Connie Lynn Sheets, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/810,359

(22) Filed: Mar. 26, 2004

Related U.S. Application Data
(63) Continuation-in-part of application No. 10/649,851, filed on Aug. 27, 2003.
(60) Provisional application No. 60/406,250, filed on Aug. 27, 2002.

(51) Int. Cl. G06F 17/60; B65D 6/28; B65D 8/18; C11D 17/00; B65D 1/24; B65D 1/36; B65D 25/04; B65D 57/00; B65D 85/00

(52) U.S. Cl. 705/14; 220/4.01; 220/500

(57) ABSTRACT

Methods of promoting the sale of a laundry product containing a composition provided in at least two components, wherein the components are located within a multiple-compartment container, a first component located within a first compartment and a second located within a second compartment, whereby the method includes the step of orienting the product such that a multiple-compartment feature is visually observable from the front consumer vantage point. Such methods may also include labeling, advertising, displaying and/or arranging on a store shelf.

### CROSS REFERENCE TO RELATED APPLICATION

This application is a Continuation-in-Part of U.S. application Ser. No. 10/649,851, filed Aug. 27, 2003 (P&G Case 9017M) which, in turn, claims the benefit of priority to U.S. Provisional Application Serial No. 60/406,250, filed Aug. 27, 2002 (P&G Case 9017P).

### FIELD OF THE INVENTION

This invention relates to systems and methods for promoting the sale of laundry products and more particularly to methods associated with packaged laundry products having at least one consumer benefit and a multi-compartment container.

### BACKGROUND OF THE INVENTION

Packaged consumer products having two or more compartments are known in the art. Such multiple compartment containers allow for the co-packaging of compositions which cannot easily, stably, or cost-effectively be packaged in standard one compartment containers. Often, these multiple compartment containers or packages allow for foaming to occur when two separate substances are dispensed and react. Recently, some isolated examples of consumer products in dual-compartment containers have seen some commercial success. Especially successful are dual-compartment adhesives, especially of the epoxy type. Other examples include, in the field of oral care, a mouthwash product and a toothpaste product marketed by Unilever under the tradename “Mentadent®”, and in the field of drain cleaners, a product called “Liquid Plumr®” marketed by Clorox. All of these products use top-dispensing containers and are free from handles, spigots and/or dispensing taps. The Mentadent products are marketed to provide the benefits of cavity protection/whiteness/fresh breath. The Liquid Plumr® drain cleaner product is marketed to provide a single benefit when the dual compositions are combined. The “Liquid Plumr®” product when placed on a shelf so that the title (front) label can be seen, hints at the dual-compartment structure in that the container is deeply grooved, but it is equally colored in both compartments and therefore it is more difficult to distinguish between the two compartments.

Packages and/or containers having two or more compartments are relatively common in product areas outside of laundry products. Contrastingly, such multiple compartment containers are rare in the laundry product field and have not yet enjoyed a commercial success to any significant extent. A rare example of such a container is one commercially available in the product “Dobbelman Duo,” distributed in Holland by Sara Lee. This product is also dispensed by top-pouring from two separate openings. The marketed product possesses a handle but no dispensing mechanism, and is marketed to consumers by two labels, one affixed to each compartment, where a first label carries a more distinctive brand identification marking (the title, or “front” label) and the second is dominated by usage instructions (the instruction or “rear” label). In order to show the title or “front” label, the container is inevitably presented on store shelves in such a manner that only one compartment is directly visible when a consumer faces a supermarket shelf carrying Dobbelman Duo bottles. Indeed despite use of the word “Duo” in the name there is ironically no other way of recognizing the nature of the product when it is seen on a supermarket shelf. This is a severe limitation in that supermarket shelves typically carry a large variety of products and the consumer is both confused by the number of products and likely to overlook such a laundry product in particular.

Therefore, a need exists to provide laundry products in multiple-compartment containers having appropriate labeling, distinguishing features, and orientation, so as to identify to consumers the availability and uniqueness of multiple-compartment laundry products.

More recently, laundry compositions have been developed as a result of much technical investigation which are in flowable form and which deliver two or more distinct benefits to the consumer. These compositions are advantageously packaged in a multiple-compartment container. In one such product, a first composition of a heavy-duty liquid detergent and a second composition of a highly effective bleach system, is provided. These compositions are suitably packaged in multiple-chamber laundry product containers. Large sizes of such products, especially those having dispensing mechanisms, such as press-taps (spigots), positioned near the base of the container and having a handle, at least one label carrying a prominent brand name, and at least one label with usage instructions, present unusual technical challenges insofar as there is a need to make important choices from a myriad of possible combinations and arrangements so as to effectively communicate the product and its benefits to the consumer, and to do so in such manner that handling of the container by the consumer in a supermarket is both safe and convenient.

The benefits associated with laundry products available in multiple-compartment containers is not always recognized by the consumer since the advertising, including labeling, store shelf facing and arranging, and shelf arrangements are not conducive to the promotion of such benefits. Therefore, there exists a need to develop the proper arrangement of multiple-compartment container, labeling, shelf-facing, and dispensing methods and mechanisms so as to provide an easily-recognizable multiple benefit to the consumer.

There is also a need to provide methods of promoting the sale of such laundry detergents to make consumers aware of the multiple benefits of these products such that consumers will be motivated to use them, leading to cleaner, softer, and/or stain-free clothes/fabrics.

### SUMMARY OF THE INVENTION

It has now surprisingly been discovered that highly preferred methods exist for the mutual arrangement of the two compartments of the multiple-compartment laundry product container, for orientation to maximize ease of access to the bottle handle, for maximizing at the same time awareness of the multiple-compartment nature of the container, for maximizing visibility of the identification label in relation to the position of the product on a store shelf, and for maximizing visual and physical balance of the multiple-compartment container for ease of handling and use. These and other related methods and the associated numerous advantages are further described in the disclosure which follows.

The present invention relates to methods of promoting the sale of a laundry product, said laundry product comprising composition provided in at least two components, wherein the components are located within a multiple-compartment container, a first component located within a first compartment and a second located within a second compartment, said method comprising the step of:

a) orienting the product such that a multiple-compartment feature is visually

observable from the front consumer vantage point.

The present invention further relates to methods of promoting the sale of a laundry product, said laundry product comprising composition provided in at least two components, wherein the components are located within a multiple-compartment container, a first component located within a first compartment and a second located within a second compartment, said method comprising the steps of:

a) displaying the laundry product in a vertical plane on a shelf such that both compartments of the bottle are simultaneously visible from the view of a consumer looking at the bottle on the shelf;

b) labeling the bottle such that the front of the bottle is in parallel with the vertical plane and is visible to consumers;

c) labeling the bottle such that directions for use and descriptions of the product are

in parallel with the vertical plane, but not visible to consumers.

The present invention relates to methods of promoting the sale of a laundry product, said laundry product comprising composition provided in at least two components, wherein the components are located within a multiple-compartment container, a first component located within a first compartment and a second located within a second compartment, said method comprising the step of:

a) providing a promotional material to a consumer, wherein said promotional material comprises information regarding an ability of said laundry product to provide a multiple-benefit to laundered fabric items and wherein a first composition comprises a heavy duty liquid composition and the second composition comprises a peracid bleach.

The present invention further relates to methods of promoting multiple-compartment, multiple benefit laundry products for cleaning and/or treating clothing. The methods encompass a variety of steps by which consumers are informed of the benefits of the multiple-compartment, multiple benefit laundry products, especially the ability to remove stains without pre-treating, in order to motivate a consumer to use a product, which they otherwise may not use, to clean and/or treat clothing, thereby resulting in cleaner/conditioned clothes for the consumer.

### BRIEF DESCRIPTION OF THE DRAWINGS

FIG. 1 on SHEET 1 is a perspective view of a multiple compartment container.

SHEET 2 is a perspective view of the method of promoting a multiple-compartment container.

SHEET 3 is a perspective view of the method of promoting a multiple-compartment container and a bottom view of the method of promoting a multiple-compartment container.

SHEET 4 is a illustrative depiction of two embodiments of the method of promoting a multiple-compartment container.

Figure SHEET 5 is a perspective view of

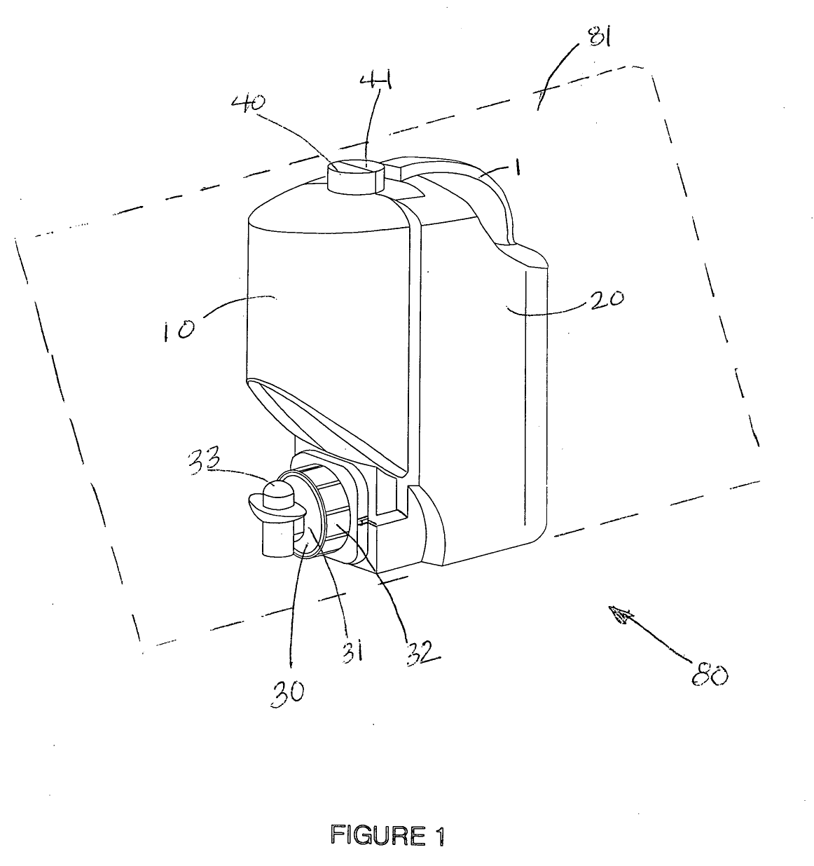

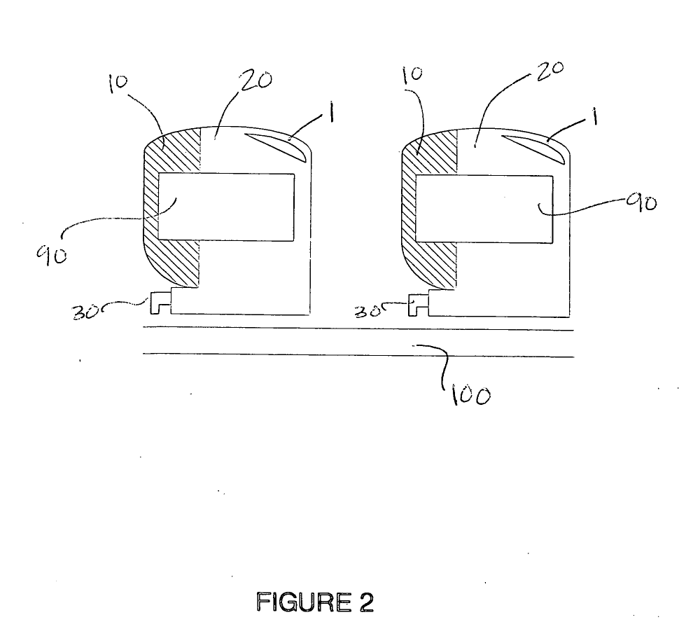

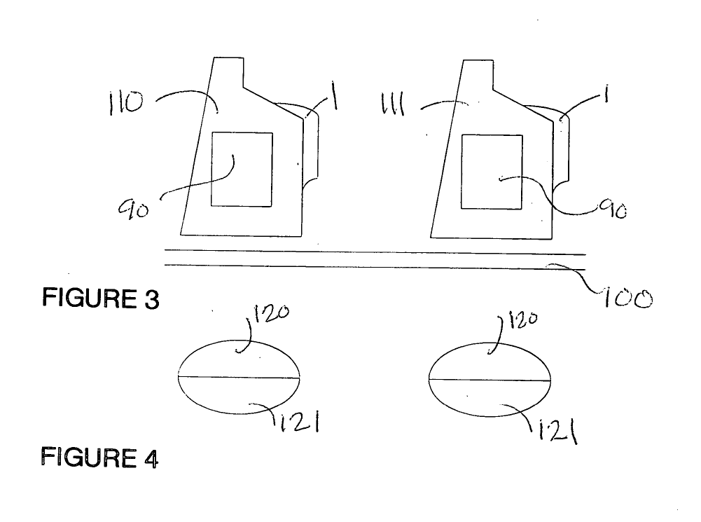

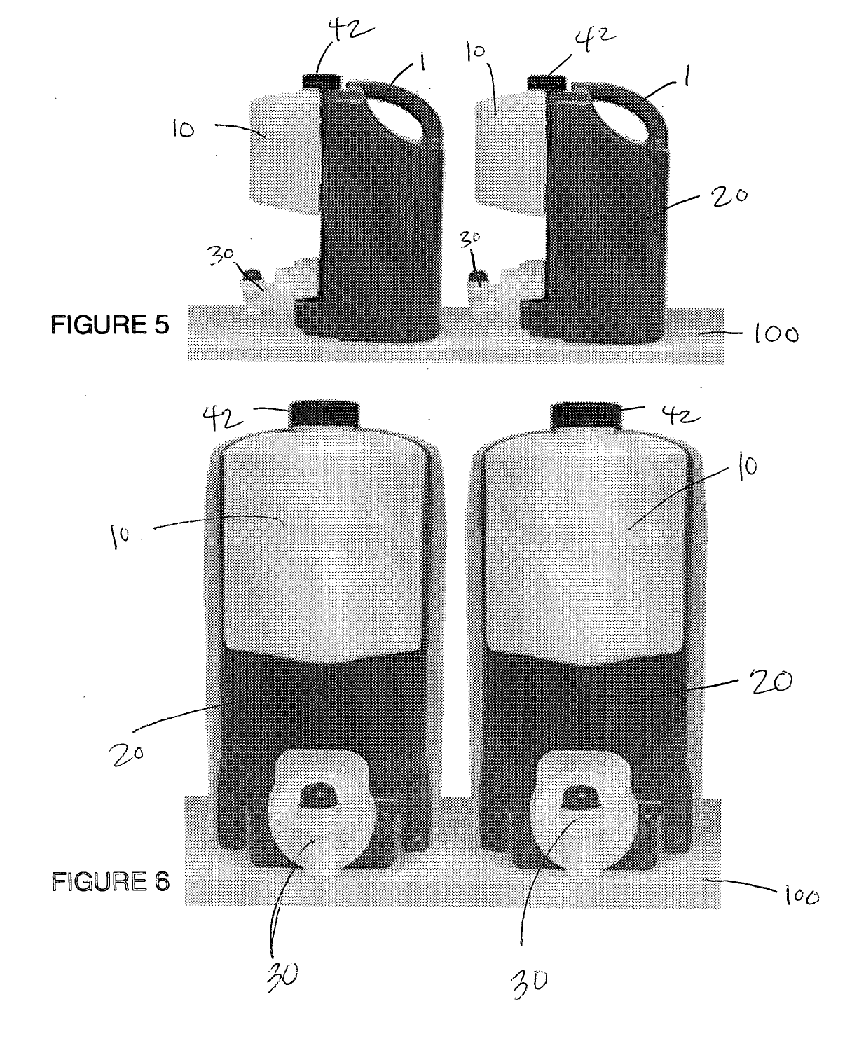

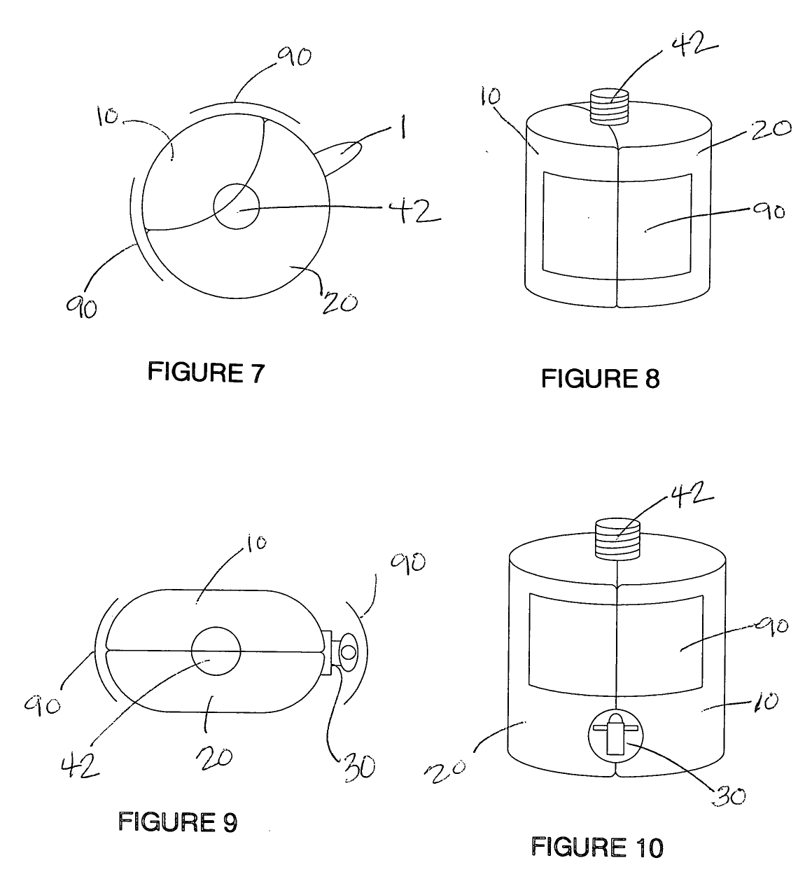

In one embodiment, the present invention makes use of containers for heavy-duty liquid detergents as depicted at FIG. 1 in Sheet 1 and as described in detail in commonly assigned U.S. patent application No. 2002/0030063 A1 to Leray and Etesse, published Mar. 14, 2002. The container of the present invention comprises at least two compartments 10 and 20, and may include a multiple-dispensing tap, 30 preferably with a plate 31, collar 32, and push button 33. The container may preferably include a venting mechanism, preferably a venting hole or holes, 40, 41. The method of promoting a multiple compartment container may include a plane, 81 and a viewpoint, 80. With the eye of a viewer positioned at 80, both compartments of the dual-chamber container can be seen simultaneously and the handle of the container, 1, is to the right. A brand-identifying label that prominently displays the name of the product, not explicitly shown in Sheet 1, is affixed to the container such that at least 50% of its surface area is substantially in parallel to plane 81.

In a second embodiment, FIG. 2, SHEET 2 shows a schematic of a face-on view of a side-by-side positioning on a shelf 100 of two multiple-compartment containers wherein in each container, one compartment, 10, is visually distinctive from a second compartment, 20, and wherein a brand-identifying label, 90, is explicitly shown and is positioned in accordance with the invention herein. Handle 1 is also shown with relative positioning. From both the difference in size between the shaded and unshaded compartments, and the visual distinction it is apparent that this is a multiple-compartment product. Note also the presence of the multiple dispensing tap 30 to the bottom left side of each container, aligned parallel with the shelf 100 and with minimum tendency to be knocked by a passer-by.

In contrast to SHEET 2, a comparative example is shown in FIGS. 3 and 4 on SHEET 3, which is a face-on schematic (FIG. 3) and cross-section view (FIG. 4) presenting two conventional dual-chamber top-pouring liquid detergent products 110, 111 on a shelf 100, wherein each container has a handle 1 and a brand-identifying label 90 identifying the front of the container and each container has equal sizes of the two chambers (shown in a cross-section view in FIG. 4 as 120 and 121). It is apparent that from the shown front consumer vantage point, only one chamber of each container is visible.

FIGS. 5 and 6, SHEET 4 represent two alternative embodiments wherein there is a pronounced mismatch in the sizes of the two compartments 10, 20. In FIG. 5, an embodiment similar to that of FIG. 2, SHEET 2 is shown. In this embodiment, a method of promoting a multiple-compartment container is shown by the front consumer vantage point view of both the first compartment 10 and the second compartment 20 are positioned such that handle 1 and multiple dispensing tap 30 are positioned to the sides of the product. The containers also show a cap 42. FIG. 6 shows an alternative embodiment of this same product whereby the method of promoting a multiple-compartment container is practiced by obtaining an acceptable visual impact of the presence of the first compartment 10, and second compartment 20 in a view wherein, on account of the size difference between compartments, both of the compartments can be seen from the side of the container coinciding with the multiple dispensing tap 30. However, this method of promoting the product has some disadvantages in that (1) the multiple dispensing tap 30 “sticks out” to a greater extent and is liable to be knocked by a person passing the shelf; (2) the handle 1 is no longer easily accessible from the front consumer vantage point for readily lifting the container, see by comparison SHEET 2; and (3) the shelf-facing bottle size is relatively smaller, limiting the label (not depicted) size and less efficiently using the shelf space provided.

On SHEET 5, FIGS. 7, 8, 9 and 10 depict alternative views and alternative embodiments of the present invention. FIG. 7 depicts a top view of a dual compartment 10, 20 container having a handle 1 and cap 42. In FIG. 7, two alternative locations for a brand identifying label 90 are shown. FIG. 8 shows the front view of the same dual compartment 10, 20 container having a handle 1 and cap 42 with the brand identifying label 90. FIG. 9 shows the top view of an alternative embodiment with dual compartments 10, 20, a multiple dispensing tap 30, and a handle 1. FIG. 9 shows two options for a location for a brand identifying label 90 to be applied. FIG. 10 shows the front view of the alternative embodiment of FIG. 9 and includes a dual compartment 10, 20 container with a multiple dispensing tap 30, a cap 42, and a brand identifying label 90.

### DETAILED DESCRIPTION OF THE INVENTION

While the specification concludes with the claims particularly pointing and distinctly claiming the invention, it is believed that the present invention will be better understood from the following description.

All documents cited are, in relevant part, incorporated herein by reference; the citation of any document is not to be construed as an admission that it is prior art with respect to the present invention

The compositions of the present invention can include, consist essentially of, or consist of, the components of the present invention as well as other ingredients described herein. As used herein, the term “comprising” means that the various components, ingredients, or steps, can be conjointly employed in practicing the present invention. Accordingly, the term “comprising” encompasses the more restrictive terms “consisting essentially of” and “consisting of.” As used herein, “consisting essentially of” means that the composition or component may include additional ingredients, but only if the additional ingredients do not materially alter the basic and novel characteristics of the claimed compositions or methods.

All percentages and ratios used herein are by weight of the total composition and all measurements made are at 25° C., unless otherwise designated.

Methods have now surprisingly been discovered to promote a laundry product, including, the mutual arrangement of the two compartments of a dual-compartment laundry product container, orientation to maximize ease of access to the bottle handle, maximizing at the same time awareness of the dual nature of the container and composition, maximizing the shelf-facing side of the bottle, maximizing visibility of the identification label in relation to position on a store shelf, and/or maximizing visual and physical balance of the dual-compartment container for ease of handling and use. Methods of promoting the sale have now surprisingly been discovered that may include the steps of advertising; displaying; orienting, arranging on a shelf 100 (preferably a store shelf); labeling; and/or increasing consumer selection awareness. This and other related methods and the associated numerous advantages are further described in the disclosure which follows.

It has been surprisingly found that the methods according to the present invention assist in the sale and merchandising of laundry products in dual-compartment containers.

Without being limited by theory, it is believed that the present invention offers numerous benefits, including the following: increased consumer awareness and appreciation of the visibly distinct compartments in a unified container, leading to validation of assertions to the potential performance of the product. In particular, the visible distinction of multiple-compartments in a unified container greatly helps validate a manufacturer's assertions about the multiple laundry benefit potential performance of the product by improving consumer understanding and appreciation of its multiple nature which is distinctive from most other laundry products. Furthermore, the labeling/compartment orientation is easily identifiable as two individualized compartments without loss of clarity to product type and use identification. Furthermore, when a gripping device is present, the arrangement and selection of the compartments, labeling and the gripping device (e.g. handle) leads to containers that are easily accessible and safe in both retail situations as well as in-home use and storage.

The laundry products herein may also include a wide variety of other ingredients. The compositions of the present invention, are described in detail hereinafter.

Definitions

As used herein, the term “promotional material” refers to a variety of marketing materials, preferably printed materials, which convey to consumers the ability of the multiple-compartment laundry products to provide multiple benefits to clothing and/or fabrics. Preferably, the promotional material further comprises information regarding the use of such laundry products to provide improved cleaning (i.e., “no need to pre-treat.”) and/or cleaning plus conditioning (i.e., softening, static control) and/or cleaning plus other fabric treatment (whitening, bleaching, color care, anti-fuzz, etc.). Promotional materials include, but are not limited to: brochures; print advertisements in newspapers, magazines, journals, and the like; labeling on packages/containers containing or encompassing the present laundry products; leaflets; radio and/or television advertisements; discount coupons (especially those redeemable upon purchase of the present laundry products); direct mail advertisements; electronic mail advertisements; fact sheets; magnets; pencils; pens; buttons; notepads; clothing, product samples, event sponsorship, endorsement, spokesperson, and the like.

Laundry Product

The methods of the present invention include a laundry product. As used herein, the term “laundry product” refers most generally to a laundry composition in a container. The term “laundry composition” refers generally to compositions designed for use in the cleaning and treatment of clothes and/or other fabrics in (or before placing in) automatic washing machines for private use and/or retail services and facilities. Compositions designed for the hand-washing or hand-laundering of fabrics are also encompassed. Compositions for laundry pre-treatment using cleaning and/or fabric care ingredients are also encompassed. Such terms differentiate the present invention from other completely different consumer products such as drain cleaners or adhesives which are not for laundry purposes and are not included in the present invention.

Preferably, the laundry product is self-supporting and can rest on a flat surface without tipping or falling over.

Laundry Composition

Laundry compositions herein more specifically include heavy-duty liquid laundry detergents (HDL's), liquid laundry detergents with bleach and/or bleach catalyst, compositions containing a fabric care component (for example, a softening, color protecting, fabric-protecting and/or anti-wrinkle active), compositions containing a fabric-treatment component, liquid detergents containing a fabric care component, and the like. For examples of laundry compositions and components thereof, see Liquid Detergents, Vol. 67 Surfactant Science Series, Edited by K. Y. Lai, Published By Marcel Dekker, Inc. 1997. See in particular, Chapter 8 on heavy duty liquid detergents from Page 261-324 and references cited therein.

Particularly preferred for use herein are dual component laundry compositions that simultaneously deliver or provide more than one laundry benefit. “Laundry benefits” in general include fabric cleaning and fabric care of consumer garments or domestic finished textile goods. For example, one component may provide cleaning benefits, while the second component provides bleaching and/or softening benefits.

“Fabric cleaning” includes the benefits from the use of surfactants and/or detergents and may involve any known mechanism such as interfacial tension lowering and/or oily soil roll-up and emulsification and/or soil suspension and/or soil anti-redeposition in the presence of surfactants optionally with polymers and/or electrolytes. Soil hydrolysis and/or depolymerization may be involved, as is commonly the case with detersive enzymes such as the common hydrolases, more specifically including proteases, amylases, lipases and mixtures thereof. Soils can vary widely and can include localized, often highly colored marks or stains, more generalized graying or discoloration, oily marks, skin debris, presence of common sooty or clay-like dirt and the like. “Fabric cleaning” in common laundry detergents includes the action of detergent cleaning ingredients such as the aforementioned surfactants, polymers and enzymes, as well as the action of bleaches, chelants and other cleaning adjuncts.

“Fabric care” includes fabric softening, anti-wrinkling, shape retention, anti-shrinkage, ease of ironing, prevention of dye-transfer (or bleeding), color-brightening, color rejuvenation, maintenance of color, prevention of abrasion and/or other similar benefits distinguished from cleaning benefits in that fabric care benefits maintain or add to the appearance, aesthetics or physical properties of fabrics without there being a required element involving soil. Often fabric care benefits are accomplished by the reverse of cleaning, for instance, by depositing materials onto fabrics rather than removing them.

In general, any two laundry ingredients, especially any two ingredients having different chemical structure or function, may be capable of providing measurably different benefits in fabric laundering. Preferred for use herein are compositions which are “capable of providing at least two distinct benefits.” As used herein, “distinct benefits“ refers to two or more benefits, such as benefits selected from whitening or stain removal, cleaning benefits, bleaching benefits, fabric care benefits, and combinations thereof, that are consumer noticeable (including but not limited to noticeable in the standard tests of textile institutes); and preferably involve a technical challenge. More preferably, the “distinct benefits” are benefits which are difficult to accomplish by merely mixing two ingredients in a unitary liquid cleaning product.

Examples of preferred sets of two distinct benefits include: (a) simultaneously providing the cleaning that is typical of an anionic detergent surfactant such as a sodium linear alkylbenzenesulfonate and the fabric care that is typical of an ester-quat fabric softener; (b) simultaneously providing the cleaning that is typical of an enzymatic detergent such as one containing a protease, and the cleaning that is typical of an enzyme-reactive bleach, such as PAP.

One particularly preferred example of a set of two distinct laundry benefits is to include a typical heavy-duty liquid detergent, or at least a surfactant and/or an enzyme, in one compartment, and in the other compartment to include any known textile treatment chemical that under normal circumstances would be considered chemically reactive with or otherwise incompatible with the contents of the former compartment. Such ingredients include all manner of textile finishes, softeners, anti-shrink agents, color protecting and/or fabric agents and the like which are chemically reactive (especially with respect to textile fibers) and/or which would normally be applied to fabrics in textile finishing rather than laundering operations.

More preferred are dual component compositions having a first component and a second component where the first and second components are physically or chemically incompatible with each other and/or where the first and second components provide a foaming reaction when combined. For examples of preferred dual component laundry compositions, see PCT Published Application WO 01/00765, to DeBuzzacarini, et al., published Jan. 4, 2001 and see PCT Published Application WO 02/22772, to DeBuzzacarini, et al., published Mar. 21, 2002.

Preferred laundry products herein are capable of providing at least two distinct laundry benefits and comprise a two component laundry composition, preferably having flowable form, packaged, located or contained within a dual-compartment container, where a first component, preferably a flowable composition, is located within a first compartment and a second component, also preferably a flowable composition, is located within a second compartment of the container. In such a case the first composition can for example be a fully-formulated heavy duty liquid detergent (preferably a laundry detergent) without bleach and comprising at least a cleaning surfactant, and the second preferably includes a bleach, bleach activator, bleach catalyst, bleach booster, or mixture thereof. Preferably, the second component comprises a fabric care ingredient, more preferably which is substantially free from cleaning ingredients.

For a partially formulated bleach or bleach catalyst in flowable form, no other component is required other than the bleach or bleach catalyst and a suitable solvent or suspending medium. In another suitable case the first flowable can be a liquid laundry detergent not containing an esterquat softener or a silicone, while the second flowable can be a fabric care composition comprising a common commercially available esterquat softener and/or a silicone with a solvent or suspending medium such that the fabric care composition or component is flowable. The formulation of liquid laundry detergents, fabric softeners, bleaches and the like is well known in the art.

The containers as described below are designed to store at least two flowable laundry compositions in separate compartments. The flowable laundry compositions stored in the first and second compartments may be the same, but are preferably different. By different it is meant that the flowable laundry compositions differ in that at least one ingredient of the first composition stored in the first compartment, is not present in the second composition stored in the second compartment, or vice versa. The flowable compositions may be in particulate, gel or paste form, but are preferably a liquid. In one embodiment of the present invention the flowable products stored in the first and second compartments have different Theological properties, for example the flowable products may have different viscosities, densities, flow properties etc.

Container

The methods of the present invention include a multiple-compartment container. As used herein, “container” refers to a closable receptacle suitable for storing and dispensing liquids and impermeable to the liquid such that it will not leak. Suitable containers have at least two compartments that are physically affixed to one another, molded together, or held in contact by a further packaging element such as a transparent plastic sleeve, without permitting the contents of one compartment to flow into the other. Containers herein enclose a volume sufficient for at least two doses or uses of a laundry composition and preferably, the compartments have a total capacity of over 50 ml. Preferably, the containers herein are together capable of holding from about 750 ml (approximately 8-10 doses) to about 8 liters (approximately 75 doses) of the laundry composition. In other words, the containers of the present invention are not of the small unit-dose “pouch” type that has recently come onto the market in some geographies, rather, the volume of the container is similar to the relatively larger volume sizes as used for single-compartment liquid laundry detergents.

Containers herein are typically capable of standing on a flat surface (or base) and may be rigid, self-supporting or flexible, including non-self supporting. However, when the container is not self-supporting it may have affixed to it, or be itself placed inside a sleeve, external package, or supplemental container. The general form of the container may thus vary and can be substantially rigid, flexible or malleable, and may be selected from bottles, boxes, bags-in-boxes, bags, sachets other than unit dose sachets, pouches other than unit dose pouches, and combinations of such forms. When the container is, for example, a box, if the box is made of a paper or other cellulose material, the box will either need to be treated or lined so as to properly be impermeable to the liquid such that it will not leak. The container form as presented on a store shelf must be rigid enough to permit it to stand upright rather than to collapse, partially collapse, or fold over (i.e. “flop”). This is important for purposes of display of both the contents and the label(s). Preferably, when the dual-compartment container is a bag, large sachet or large (non-unit dose) pouch, it is supported in a second substantially rigid container or affixed to an element that permits the overall packaging assembly to stand upright.

The process used for making a container as described above depends on the size, shape and materials of the container being made. In the case where the container is rigid, suitable manufacturing processes may be appropriately chosen by a skilled person. Such processes may include, but are not limited to: injection molding, injection-blow-molding, or extrusion-blow-molding. In the case where the container is flexible and/or malleable, suitable manufacturing processes can again be selected by the skilled person. In such a case, a bag, sachet or large pouch may also be produced by a forming and sealing process, with the rigid neck or necks being sealed or integrated on one side of the bag, sachet or large pouch. In a preferred embodiment the container is made by molding more than one separate compartments, by any suitable means, which are then irreversibly joined to each other, using any suitable means, for example, adhesive, lock and key system of cooperating surfaces etc. In an alternative preferred embodiment the first and second compartments are made by irreversibly pinching along the length of a single compartment container, thereby providing two separate compartments.

One or more of the multiple-compartment containers according to the present invention may be manufactured from any of the common plastics commonly commercially used in packaging liquid laundry products. Composite materials may also be used, but common paper is generally unsuitable for packaging liquids. Alternatively, for concentric multiple chambered containers, in which compartments are inside of one another, artwork on the front-facing label can be used to communicate the multiple compartments.

Compartments

As discussed above, the containers of the present invention have at least two compartments. Preferably, the compartments are differentiated from one another by non-equivalent selections in two or more of the following features:

(a) color

(b) degree of transparency vs. opacity

(c) size

(d) color of stored component (when a compartment is transparent or partially-transparent) Preferred containers for use herein have a compartment difference in at least (a) plus one of (b)-(d). Preferably, each compartment is different from the other compartments by at least one characteristic selected from size, color, transparency, or mixtures thereof.

a) Color Difference

The dual-compartment container of the present invention may have two opaque (or nearly opaque) color compartments which are visibly distinct from one another by variance in color. For example one compartment may appear blue and another white, one blue and another orange, one red and another white, one light blue and another dark blue, one green and another blue. Color difference can also be provided for by using one or two transparent compartments and coloring the liquid contents thereof, preferably with a high degree of color contrast. Color difference may also be affected on a container that has two like-colored compartments by applying differently colored labels, sleeves, dyes, and/or inks to the different compartments.

b) Transparency

The individual compartments of the dual-compartment container of the present invention may be manufactured from materials having varying transparency which can range widely. For example, visible light may be transmitted from 0% to 100% through the packaging material or may be sufficient only for partial light transmission. Optionally, the materials of the container may contain one or more filter mechanisms, including, but not limited to, an ultraviolet light filter to protect the component color integrity and other light sensitive materials in the product. Additionally, the individual compartments may be partially opaque (or nearly opaque) and partially transparent, such as, for example, when a transparent portion is included on the side of a compartment in order to allow the consumer to visualize the level of laundry product remaining. Alternatively, a magnifying window can be placed on a container compartment or compartments so that the contents are more readily visible.

c) Size

The minimum size of the total multiple-compartment container volumes of the present invention is that which is suitable for providing at least two standard American washing machine doses of laundry product. Preferably, the containers of the present invention are capable of holding from about 750ml up to about 8 liters. The individual compartments may be equivalent in size, or may be of different sizes, particularly when the sizes are suitable for dual compositions used in different ratios in the final product (such as 4 parts liquid detergent, 1 part bleaching composition). Preferably, a first compartment holds the same volume as a second compartment.

d) Color of Composition

The multiple-compartment containers of the present invention may be substantially transparent and contain a different colored composition in one component from the composition in the other compartment or compartments. In such an embodiment, each of the compartments of the container are distinguishable by the difference in appearance of the compositions seen through the transparent, or nearly transparent container.

Preferred Container

Preferably, the multiple-compartment container of the present invention comprises two compartments which differ in color, are of different sizes, and contain differently colored liquids. More preferably, the multiple-compartment container of the present invention is selected from those described in commonly-assigned U.S. patent application No. 2002/0030063 A1, to Leray and Etesse, published Mar. 14, 2002.

Label

As used herein, the term “label” means an item used to identify something, such as a piece of cardboard, cardstock, paper, plastic (e.g. in-mold label) and/or cloth ascribed and attached to (or associated with) an article to designate its origin, owner, contents, use, destination, price, benefits, identity, contact information, or size, etc. The labels herein may be physically affixed to the container, may be shrink-wrapped around or onto the container, may be tied to the bottle with string or other connecting means, or may be printed directly onto the container by traditional printing means (or even new technologies such as wax transfer). The labels are preferably plastic with a self-adhesive backing that allows for easy affixation on the container. More preferably, the labels are in-mold plastic labels with adhesive placed in the mold prior to extrusion blow molding.

The labels of the present invention may generally mimic the shape of the container. The label may be selected from partially wrap-around labels, wrap-around labels, shrink-wrap labels, stickers, hang-tags, and labels conveying the name of the product. Preferably, in-mold labels are used.

The multiple-compartment containers of the present invention may include at least one label that helps to properly identify the “front consumer vantage point.” Additional labels may also help to identify the “rear consumer vantage point,” and a “side consumer vantage point.” Therefore, the function of these additional labels is to facilitate the correct positioning of the bottles on the shelf 100, allowing the consumer to fully benefit from the invention. Reference is made to SHEET 1, FIG. 1 for representation of the terms “front consumer vantage point,” “rear consumer vantage point,” and “side consumer vantage point.” All of these vantage points are arranged with reference to the vertical axis of the product. As can be seen for example, in FIG. 1, SHEET 1, when the vertical plane “81” is mapped through the middle of the laundry product, the front (as observed in the 80 direction) and rear (observed in the opposite direction to 80) vantage points are arranged substantially in parallel with this plane. The side consumer vantage points are arranged as substantially perpendicular to the vertical plane.

As may be seen in FIG. 1, SHEET 1, as used herein, the term “front consumer vantage point” refers to the vertical plane along the edge of the product which represents the image preferably viewed by a consumer looking at the product on a store shelf (i.e., looking in the direction 80). In FIG. 1, SHEET 1, by viewing the product in the 80 direction, the consumer would see both compartments 10, 20, the handle 1, and the side of the multiple dispensing tap 30. This vantage point is normally seen by the consumer from a substantially direct point of view, whether the consumer's view be from directly in front of the product to slightly above, slightly to either side, or slightly below the product. This vantage point is that commonly preferred by the seller of the laundry product to be first noticed by the consumer, therefore this vantage point is normally labeled in larger font with the trademark logo or product name, along with the size of the product, information on key features, and/or warnings for use.

As used herein, “front” generally refers to the part or surface of anything which seems to look out, or to be directed forward; the fore or forward part; the foremost rank; the opposite to back or rear; the most conspicuous part. As used herein, “front side” is meant generally to mean the portion of the container identified by the “brand-identifying label,” as it is the portion of the container that is intended for “first viewing” by the consumer, whether it be on a store shelf or in an advertisement. As used herein, the terms “brand-identifying label” or “brand-identifier label” generally refers to the label that contains the most prominent brand identification (i.e. logo, trademark, title, word, tradedress), irrespective of its size. Although a container in the abstract may not have an obvious “front” side, or may have more than one side that can be selected as a “front” side by placement of appropriate labeling, according to the invention herein, a “front” side is always selected such that both of the multiple-compartments are at least partially visible from the front consumer vantage point. Therefore, as used herein, the “front” of the container should not be selected such that only one compartment of the multiple-compartment is visible. The brand-identifying labels herein are used to recognize the appropriate “front” side and to clearly indicate that this is the side that should be first viewed by the consumer.

Similarly, as may be seen in FIG. 1, SHEET 1, the term “rear consumer vantage point” refers to that side of the laundry product which normally is not seen by the consumer when the product is on the shelf. This vantage point is on the opposite side of the product from the front consumer vantage point and is generally parallel thereto when the container has four sides.

The term “side consumer vantage point” is that view of the product which is normally only partially seen by the consumer viewing the product on a store shelf However, if the product is shelved on the end of a shelving unit, or on a shelving unit which is sparsely filled, it is entirely possible that the side consumer vantage point, whether it be the “right side consumer vantage point” (view from the right) or the “left side consumer vantage point”(view from the left), is partially viewed.

Although the front, rear, and side vantage points are easily identified when the container footprint is generally square or rectangular in shape, it should be understood that round, oval, or even irregular shaped containers may be properly identified with front rear and side vantage points, even though such sides may be curved, wavy, and/or non-parallel.

The three points other than the front vantage point may be labeled with a variety of informational markings, including directions for use, manufacturing information, universal pricing code, warnings, intellectual property rights, etc. The typeface normally used on any rear or side consumer vantage point label is typically relatively small in relationship to the typeface used on any front consumer vantage point label.

In addition, one or more other types of identifying labels may be used, such as those affixed by string looping through a hole in the label and about any suitable attachment point on the container, including, but not limited to, the handle, the cap (or caps), the press tap, and/or the spigot.

Other types of information which may be conveyed to the consumer (or store staff) may include safety information, instructions for use in a series of laundry products, and/or laundry tips.

It is also theorized that such information normally appearing on labels could also be conveyed to the consumer by other store/shelf signage, wording in advertisements, leaflets, brochures, similar products, etc.

Preferably, information included on the label or other information convenyance includes instructions that identify the multiple-benefits of the compositions, such as the wording “no need to pre-treat”; a statement to the effect that because of the multiple component composition, there is no need to pretreat stains; a statement that because of the multiple component composition, the laundry product alone works as well, or better than, the use of a combination of a heavy duty liquid detergent and pretreater and/or pre-spotting composition; and/or identification of the product as performing such that there is no need for a pre-treating composition.

Preferably, the multiple-compartment container includes a label that is visible simultaneously with the first compartment and the second compartment, more preferably, the label is a brand-identifying label.

Optional Features

The multiple-compartment containers herein may also encompass one or more of the following features:

Dispensing Mechanism

The compositions in the multiple-compartment containers herein may be released from the container by simple top-pouring openings, or may be dispensed by one or more dispensing mechanism(s) such as taps, spigots, dial plates, pumps, screw plates, etc. Other dispensing mechanisms suitable for liquid detergents and/or liquid fabric softeners may also be included.

The tap or spigot is preferably included that dispenses from all compartments at the same time, preferably one which is adaptable for dispensing different ratios of product from each of the compartments (i.e. 4 parts from first compartment composition, 1 part from second compartment The dispensing mechanism may also be adapted to dispense a 1:1 ratio of each dual-composition composition within a dual-compartment bottle. Examples of dispensing mechanisms (including taps and dial plates) useful herein are found in U.S. Published patent application No. 2002/0030063, Published Mar. 14, 2002.

The dispensing mechanism may include a valve system which helps to regulate the flow of the two component compositions to achieve the proper ratio.

The dispensing means may also be provided with extended channels, i.e., a spout, which can be arranged as to provide the most effective trajectory of flowable product for collection by the user.

Venting Mechanism

At least one venting mechanism and/or cap is preferably used on the multiple-compartment container to enclose at least one of the orifices of the product. As used herein, a “venting mechanism” refers to a system of air and/or gas and/or liquid transfer regulation. The function of the venting mechanism is to discourage explosion or implosion due to off-gassing and/or gas depravation (such as due to changes in temperature, pressure, etc.). The venting mechanism may perform by active and/or passive means. Passive venting may include a membrane, liner, or module to allow air/gas into or out of the container, but not liquid. Active venting may include plugs and/or caps that can be removed and/or opened to allow unrestricted air flow into or out of the package. Active venting may also allow liquid to flow into and/or out of the package. An example of active venting is a removable, or partially removable cap, insert, lid, and/or plug. Useful venting mechanisms are disclosed in the following: Netherlands patent application NL 1018746, published on Sep. 16, 2002 to Sara Lee; PCT Published Application WO 01/66421, Published Sep. 13, 2001 to Procter & Gamble; PCT Published Application WO 96/30486, Published Oct. 3, 1996 to Warwick; and PCT Published Application WO 95/19919, Published Jul. 27, 1995 to Colgate.

In a preferred embodiment, the multiple-compartment container includes a venting mechanism on the upper half of the container and a dispensing means attached to the lower half of the container. More preferably, the dispensing means is attached in the lower eighth of the container.

Gripping Means

The products of the present invention may further include a gripping means. The gripping means may be for example, a handle 1. The handle may be integral to and/or an extension of the multiple-compartments. Alternatively the gripping means may comprise an area on the surface of the container which is modified to facilitate grip by the user. For instance, texturing on the surface of the container to increase friction. Preferably, the gripping means is incorporated into the bottle such that it is easily accessible when on a shelf and/or is easily lifted from one point to another. As used herein, “accessible” means to be convenient, handy, at hand.

In some embodiments, a multiple-compartment container with multiple handles in optimal orientations to the multiple-compartments may be preferred in order to further improve ease of handling, such as for larger, heavier bottles.

Preferably, the handle is attached to the container so as to be observable from the front consumer vantage point.

Methods of Promoting the Sale of a Multiple-Compartment Laundry Product

As used herein, “methods of promoting the sale” includes steps of advertising; displaying; orienting, arranging on a shelf (preferably a store shelf); labeling; and/or increasing consumer selection awareness.

Generally speaking, the methods of the present invention are drawn to the identification of the multiple compartment container and corresponding multiple benefit of the laundry product to maximize consumer realization of such features. The present invention recognizes that it is important for the consumer to recognize the benefit of a multiple-compartment laundry product to justify the added cost and complexity of a multiple-compartment container. When the consumer realizes that the laundry product has separate compartments that provide at least two separate benefits and/or some consumer meaningful benefit such as task simplification, the sales of the product will go up. Therefore, the methods of the present invention are drawn to the mutual arrangement of the two compartments of a multiple-compartment laundry product container for orientation of the bottle on display; orientation of the bottle on a shelf to maximize ease of access to the optional gripping means; maximizing awareness of the multiple nature of the container and composition; maximizing visibility of the identification label in relation to position on a store shelf; maximizing visual and physical balance of the multiple-compartment container for ease of handling and use; and/or maximizing occupancy of available shelf-space.

Steps of Advertising

The methods of promoting the sale of a laundry product, may include a step of advertising the laundry product and/or the benefits therein. Preferably, the step of advertising includes providing promotional material to a consumer, wherein the promotional material comprises information regarding an ability of said laundry product to provide a multiple-benefit to laundered fabric items.

Preferably, the promotional material includes advertising claims that discuss the benefits of the multiple-compartment container and/or multiple component compositions. More preferably, the laundry products of the present invention are advertised in conjunction with language selected from the following: dual-action, dual-effective, foaming, no need to pre-treat, effective as a regular laundry detergent and pre-treater combined, no need for separate bleach, no need for separate pretreater, detergent plus fabric conditioner, detergent plus softener, detergent with color-lock, detergent with color care, with freshness enhancers, two-phase, double-action, anti-microbial, etc.

Steps of Displaying

The present methods of promoting the sale of a laundry product may include a step of displaying the laundry product. As used herein, “displaying” refers to the manner in which the multiple-compartment containers of the present invention are presented to the consumer and/or the general public in conjunction with promotional materials such as in television or print advertisements, billboards, retail store shelves, in-store demonstrations, etc. Preferably, the step of displaying the product includes having the product portrayed in a venue selected from television advertisements, billboards, clothing, fabrics, samples, promotional materials, photographs, web pages, cartoons, non-photographic images, or print media.

Steps of Orienting

The present methods of promoting the sale of a laundry product may include the step of orienting the product such that a multiple-compartment feature is visually observable from the front consumer vantage point. As used herein, a “multiple-compartment feature” refers to the fact that the container has at least two compartments which contain separate compositions. Preferably, the orienting step is preceded by a step of first identifying a front consumer vantage point associated with the product. Such identification may be assisted by the use of labels. The methods herein may include orienting the product in a vertical plane on a shelf 100. The term “orienting the product in vertical plane on a shelf” as used herein, includes, but is not limited to: rotating the product as it stands erect on a substantially flat container base (such a base is present on most conventional containers) or: directly placing the product on the shelf such that it is equivalently rotated.

Preferably, the step of orienting the product further includes orienting the product and a label such that the label, first compartment, and second compartment are simultaneously visibly observable.

The step of orienting the product may include locating the product on a substantially horizontal fixture selected from shelves, kiosks, or countertops. The step of orienting the product may include orienting the product and presenting to consumers in a medium selected from: print media, photographs, web pages, cartoons, non-photographic images, television commercials, store shelves, kiosks, or combinations thereof.

Preferably, the step of orienting the product is repeated on at least one additional product located substantially adjacently on a substantially horizontal portion of a store shelf. The step of orienting the container may be applied in sequence to two or more of similar or identical containers located in an array and presented to consumers in a medium selected from: print media, photographs, web pages, cartoons, non-photographic images, television commercials, store shelves, kiosks, or combinations thereof.

The step of orienting the product may include a step of co-locating the laundry product (preferably on a store shelf or in a consumer presented media) with at least one other single-compartment laundry product wherein although the laundry products are different by at least one ingredient, the products have the same color scheme.

Steps of Arranging on a Store Shelf

As used herein “step of arranging on a store shelf” refers to the practice of placing the multi-compartment laundry product for sale on a shelf, display case, kiosk, etc. and then orienting the product such that the appropriate consumer vantage point is substantially visible. Preferably the methods herein include a step of arranging the product on a store shelf wherein the step includes displaying the bottle in a vertical plane on the shelf such that both compartments of the bottle are simultaneously visible from the view of a consumer looking at the bottle on the shelf, labeling the bottle such that the front of the bottle is in the same vertical plane and is visible to consumers; and labeling the bottle such that directions for use and descriptions of the product are on the same vertical plane, but not visible to consumers.

According to the present invention, more than one multiple-compartment container may be arranged on a store shelf (such as a standard shelf found in a consumer drug store, a supermarket, a club store such as Sam's®, Costco®), in such a manner as to allow the consumer to clearly identify the multiple-compartment nature of the laundry product and allow for ease in access and lifting.

In order to correctly orient the containers on the store shelf, the following steps may be taken:

1) transport more than one multiple-compartment container to the store shelf,

2) arrange the multiple-compartment containers on the store shelf such that; a) both compartments are visible from the front consumer vantage point, preferably providing visually distinctive appearance with brand-identifying label facing the front.

In one embodiment, the present invention involves methods associated with the communication to consumers of the benefits of a heavy-duty liquid laundry detergent (HDL) with bleach contained in a separate compartment of a dual-compartment HDL bottle equipped with a handle 1 and a multiple dispensing tap 30 which may be a press tap or spigot or greater than one tap and/or spigot or tap and/or cap 42.

The two compartments 10 and 20 are oriented side by side in a manner in which one or more brand-identifying label(s) 90 is/are oriented along a plane that is essentially parallel to the plane through the cross section of the center of the two compartments. In addition, the handle 1 for lifting the dual-compartment bottle is positioned in a manner in which the handle is also oriented along a plane that is essentially parallel to the plane through the cross section of the center of the two compartments. Both of these criteria are preferred in order to maximize the advantages listed above.

With respect to SHEET 1, the two compartments are oriented side by side in a manner in which the identification label would be oriented along a plane 81 that is essentially parallel to the plane through the cross-section of the center of the two compartments. In addition, the handle 1 for lifting the dual-compartment bottle is positioned in a manner in which the handle 1 is also oriented along a plane 81 that is essentially parallel to the plane though the cross-section of the center of the two compartments 10, 20.

Plane 81 is also parallel to the plane defining the front of a shelving arrangement in a store, and direction 80 at 90 degrees ±45 degrees to plane 81 is a typical viewing angle by the consumer (“front consumer vantage point”). Accordingly, the consumer gets the visual benefit of seeing the potentially visually distinguishable components of the product in compartments 10 and 20.

Steps of Labeling

As used herein, a “step of labeling” generally refers to the step of providing a label in conjunction with the laundry products herein. Preferably, the front of the container should be easily recognizable by the consumer, the store owner, and/or the distributor as that which is to be the first and primary view of the laundry product. The label is preferably affixed to the container such that it encourages the placement of the laundry product on a store shelf, display case, pre-formed displayable pallet, end aisle display, window display, center aisle display, co-product display, other general store display common within the trade, kiosk, advertisement, etc. such that both compartments are clearly visible.

Preferably, the method of promoting the sale further includes a step of positioning and affixing a brand-identifying label 90 to the container such that the label is visible from the front consumer vantage point.

Methods of Increasing Consumer Selection Awareness

The present invention also relates to a method of simplifying the process of locating and acquiring multi-benefit laundry product that is located together in the same multi-component container rather than different locations in the store. Such a method may include the steps of providing a coordinated system of containers and labels. As used herein, “coordinated system of containers and labels” may include (a) an overall product/brand line-up having a small size and a large size, where the overall product line-up shares artwork or design elements indicating that the two sizes correspond to the same brand and (b) wherein the small size is a multiple-chamber top- dispensing bottle and the large size is a multiple-chamber bottom dispensing bottle preferably having a press tap or spigot positioned so that pouring from the top of the bottle is not necessary.

Method of Providing Proper Proportion

The present invention also relates to a method of providing the desired proportion of individual components of a multi-benefit regimen to avoid running out of one or having to purchase one item more often than the other.

Method of Minimizing Store Stocking Steps

The present invention also relates to a method of providing a multiple-compartment product in place of two single-compartment products to deliver equivalent benefits thereto and thus reduce the time and expense of multiple product store-shelf stocking steps.

Service Business Use

Any of the above systems, compositions and methods can be used in a laundry service business, for example in a dry-cleaning establishment, an institutional laundry (such as school, hotel or military field laundry), a hospital, an institution, a hotel, or similar, without departing from the spirit and scope of the invention.

### EXAMPLES

The following examples I through III further describe and demonstrate embodiments within the scope of the present invention. The examples are given solely for the purpose of illustration and are not to be construed as limitations of the present invention, as many variations thereof are possible without departing from the spirit and scope of the invention.

### Example I

A method of promoting a laundry product is praticed as follows. First, a laundry product according to the methods of the present invention is assembled as a dual-compartment bottle, according to FIG. 1 on SHEET 1 contains a first laundry composition that includes a peroxyacid bleach in one compartment 10 and an aqueous heavy duty liquid laundry detergent including a surfactant in the other compartment 20. The compartments of the bottle both have venting mechanisms, i.e., holes at the top of their respective compartment (40, 41). These openings are jointly covered by a venting cap (not shown in FIG. 1). Both compartments 10, 20 of the bottle are arranged such that the contents of each are simultaneously dispensed by a multiple dispensing tap (30) that is located underneath the compartment 10. The bottle has a handle 1 that is oriented along plane 81 for ease in lifting.

The front consumer vantage point is selected as that viewed from the direction 80.

Therefore, the left side consumer vantage point is perpendicular to the left to the direction viewed from the 80 direction and the right side consumer vantage point is perpendicular to the right to the direction viewed from the 80 direction. The rear consumer vantage point is hidden in this portrayal.

As can be seen from FIG. 1, both compartments 10, 20 of the laundry product are visible in the front consumer vantage point and the handle 1 is easily accessible. At least one brand-identifying label 90 (not shown) is attached to either or both of the compartments (10 and 20) indicating the name of the product.

The laundry product is placed on a store shelf such that the front consumer vantage point is substantially visible to a consumer standing by the shelf.

### Example II

A laundry product according to the methods of the present invention is assembled as follows.

Example II is essentially the same as Example I except that the bottle's consumer vantage points are reversed such that the rear consumer vantage point of Example I and FIG. I is now the front consumer vantage point of Example II.

Both compartments of the laundry product are visible in the front consumer vantage point and the handle is easily accessible.

The laundry product is photographed in this configuration and the photograph of the product is incorporated into promotional literature.

### Example III

A method of promoting a laundry product is practiced by aligning on a store shelf, a two-by two array of laundry products according to Example I. A sketch of this alignment is provided in SHEET 2.

While particular embodiments of the subject invention have been described, it will be obvious to those skilled in the art that various changes and modifications of the subject invention can be made without departing from the spirit and scope of the invention. It is intended to cover, in the appended claims, all such modifications that are within the scope of the invention.

What is claimed is:

1. A method of promoting the sale of a laundry product, said laundry product comprising a composition provided in at least two components, wherein the components are located within a multiple-compartment container, a first component located within a first compartment and a second located within a second compartment, said method comprising the step of:
a) orienting the product such that a multiple-compartment feature is visually observable from the front consumer vantage point.

2. A method according to claim 1 wherein the composition is capable of providing at least two distinct laundry benefits.

3. A method according to claim 1 wherein the step of orienting the product further comprises orienting said laundry product and a label such that the label, first compartment, and second compartment are simultaneously visibly observable.

4. A method according to claim 1 wherein the method further comprises a step of:
a) positioning and affixing a brand-identifying label to the container such that the brand identifying label is visible from the front consumer vantage point.

5. A method according to claim 1 wherein each compartment is different from the other compartments by at least one characteristic selected from size, color, transparency, or mixtures thereof.

6. A method according to claim 5 wherein the first compartment holds the same volume as the second compartment.

7. A method according to claim 1 wherein the multiple-compartment container further comprises a gripping means comprising a handle.

8. A method according to claim 7 wherein the handle is attached to the container so as to be observable from the front consumer vantage point.

9. A method according to claim 1 wherein the first component comprises a heavy duty liquid detergent.

10. A method according to claim 9 wherein the second component comprises a bleach, bleach activator, bleach catalyst, bleach booster, or mixture thereof.

11. A method according to claim 9 wherein the second component comprises a fabric care ingredient.

12. A method according to claim 1 wherein the step of orienting the product comprises locating the product on a substantially horizontal fixture selected from shelves, kiosks, or countertops.

13. A method according to claim 1 wherein the step of orienting the product is repeated on at least one additional product located substantially adjacently on a substantially horizontal portion of a store shelf

14. A method according to claim 1 wherein the step of orienting the container is applied in sequence to two or more of said containers located in an array and presented to consumers in a medium selected from: print media, photographs, web pages, cartoons, non-photographic images, television commercials, store shelves, kiosks, or combinations thereof.

15. A method according to claim 1 wherein the multiple-compartment container further comprises a dispensing mechanism selected from the group consisting of taps, spigots, dial plates, pumps, screw plates, etc.

16. A method according to claim 1 wherein the product is self-supporting and the step of orienting the product further comprises orienting the product in a vertical plane on a shelf; provided that:
a) the multiple-compartment container further comprises a label that is visible simultaneously with the first compartment and the second compartment; and
b) the label includes a brand identifier of the product.

17. A method according to claim 1 wherein the container is capable of holding from about 750ml to about 8 L of liquid.

18. A method according to claim 1 wherein a label including a phrase “no need to pre-treat” is affixed to the container and is at least partially visible from the front consumer vantage point.

19. A method of promoting the sale of a laundry product, said laundry product comprising composition provided in at least two components, wherein the components are located within a multiple-compartment container, a first component located within a first compartment and a second located within a second compartment, said method comprising the steps of:
a) displaying the laundry product in a vertical plane on a shelf such that both compartments of the bottle are simultaneously visible from the view of a consumer looking at the bottle on the shelf;
b) labeling the bottle such that the front of the bottle is in parallel with the vertical plane and is visible to consumers;
c) labeling the bottle such that directions for use and descriptions of the product are in parallel with the vertical plane, but not visible to consumers.

20. A method of promoting the sale of a laundry product, said laundry product comprising composition provided in at least two components, wherein the components are located within a multiple-compartment container, a first component located within a first compartment and a second located within a second compartment, said method comprising the step of:
a) providing a promotional material to a consumer, wherein said promotional material comprises information regarding an ability of said laundry product to provide a multiple-benefit to laundered fabric items and wherein a first composition comprises a heavy duty liquid composition and the second composition comprises a peracid bleach.
